(19) United States
(12) Patent Application Publication
(10) Pub. No.: US 2006/0200354 A1
(43) Pub. Date: Sep. 7, 2006

(54) Medical practice support system

(75) Inventors: Masaru Ito, Yokohama (JP); Masahide Yamaki, Tokyo (JP); Takechiyo Nakamitsu, Tokyo (JP); Kiyoshi Sekiguchi, Tokyo (JP); Hiroyuki Ushifusa, Tokyo (JP)

Correspondence Address: OSTROLENK FABER GERB & SOFFEN, 1180 AVENUE OF THE AMERICAS, NEW YORK, NY, 100368403, US

(73) Assignee: Olympus Corporation

(21) Appl. No.: 11/353,676

(22) Filed: Feb. 14, 2006

(30) Foreign Application Priority Data
Feb. 15, 2005 (JP) 2005-037827

(51) Int. Cl. G10L 21/00

(52) U.S. Cl. 704/275

(57) ABSTRACT

A medical practice support system according to the present invention comprises a voice conversion unit for obtaining a voice and converting the voice to an electric signal for making voice data; a voice recognition unit for recognizing the voice data and generating character information by converting the voice to a character string, or controlling an operation of an equipment corresponding to the recognition result; and a control unit for controlling the voice recognition unit, wherein the control unit controls the voice recognition unit to make it generate character information if the voice recognition unit judges that the voice data is instruction information for making the character string be generated.

### CROSS REFERENCE TO RELATED APPLICATION

This application is based on and claims the benefit of priority from the prior Japanese Patent Application No.2005-37827 filed in Japan on Feb. 15, 2005, the entire contents of which are incorporated by this reference.

### BACKGROUND OF THE INVENTION

1. Field of the Invention

The present invention relates to a medical practice support system capable of controlling an electronic equipment used for a medical equipment by voice.

2. Description of the Related Art

Surgery is performed by using an endoscope in recent years. In the case of cutting away a certain body tissue by using an aeroperitoneum apparatus used for inflating an abdominal cavity and a treatment apparatus for performing a surgical procedure or stopping bleeding by using a high frequency cauterization apparatus, these treatment can be carried out by observing by way of an endoscope.

An endoscopic surgery system has a system controller enabling connections to various apparatuses used for an endoscopic examination and endoscopic surgery (e.g., a light source apparatus, a video processor, a high frequency cauterization apparatus and aeroperitoneum apparatus necessary for a surgical operation, a video recording apparatus or peripheral equipments such as printer for recording images during a surgical procedure, et cetera). The system controller is connected to an operator panel and a display panel enabling a display of a setup value, et cetera. Use of the operator panel and display panel enables a centralized control of the peripheral equipments connected to the system controller (e.g., a laid-open Japanese patent application publication No. 2002-336184).

An endoscopic surgery system also for example comprises a plurality of equipments including a display panel, a remote operation apparatus, a centralized operator panel, a microphone, etcetera (e.g., laid-open Japanese patent application publications No. 2002-336184, No. 2001-344346, No. 08-52105 and No. 06-96170). This enables an easy operation and control of a plurality of apparatuses and improves an operability of the system.

The display panel, including an LCD (liquid crystal display) panel for example, is a display unit for a surgical operator (also simply “operator” hereinafter) to confirm setup states of various equipments in a sterilized zone. A remote operation apparatus, comprehending a remote controller, is a remote operation unit for an operator to operate in a sterilized zone for changing the functions and setup values of the various equipments. The centralized operator panel includes operator switches, on a touch panel, of the various equipments for assistants, such as a nurse, to operate in an unsterilized zone to change the functions and setup values of the various equipments. A microphone is used for operating the various equipments by voice.

As described above, there exists an endoscopic surgery system comprising a voice-operated control function and/or a dictation function recently. The voice-operated control function is the one for operating connected equipments by recognizing a pronunciation of the user by a voice recognition. The dictation function is the one for converting, to a text data, a voice-recognized finding content pronounced by an operator during a surgical procedure and examination for assisting in creation of an electronic medical record, et cetera. Incidentally, an object having such a voice-operated control function and/or a dictation function is called a voice recognition engine.

FIG. 1 shows a conventional dictation-use microphone 110. A microphone body 113 of the dictation-use microphone 110 is equipped by a microphone 111 and a start switch 114. In a conventional case of recording procedures by a dictation during an endoscopic surgery, a dictation has been started by pressing the start switch 114. That is, pressing the start switch 114 carried out a text creation processing by differentiating between an ordinary conversation and dictation content.

FIG. 2 shows a conceptual diagram of a conventional voice recognition unit having a voice operation processing unit 120 and a dictation processing unit 123. Referring to FIG. 2, a voice recognition unit 130 lets a mode changeover unit 126 changeover a voice operation control mode and dictation mode.

When changing over to the voice operation control mode, the voice operation processing unit 120 lets a voice recognition engine 121, which is used for a voice operation control function (i.e., voice operation), recognize a voice input from a microphone 127 for carrying out a processing 122 for operating the connected equipments.

When changing over to the dictation mode, the dictation processing unit 123 lets a voice recognition engine 124 used for a dictation recognize a voice input from the microphone 127 for carrying out a processing 125 for converting the voice to a character string.

### SUMMARY OF THE INVENTION

A medical practice support system according to an aspect of the present invention comprises: a voice conversion unit for obtaining a voice and converting the voice to an electric signal for making voice data; a voice recognition unit for recognizing the voice data and generating character information by converting the voice to a character string, or controlling an apparatus operation corresponding to the recognition result; and a control unit for controlling the voice recognition unit, wherein the control unit controls the voice recognition unit to make it generate character information if the voice recognition unit judges that the voice data is instruction information for making the character string be generated.

A medical practice support system according to another aspect of the present invention comprises: a voice conversion unit for obtaining a voice and converting the voice to an electric signal for making voice data; a voice recognition unit for recognizing the voice data and generating character information by converting the voice to a character string, or controlling an operation corresponding to the recognition result; and a control unit for controlling the voice recognition unit, wherein the control unit controls the voice recognition unit so as to make it generate character information if the control unit receive a notice signal for giving effect to imaging an endoscope image.

A medical practice support system according to yet another aspect of the present invention comprises: a voice conversion unit for obtaining a voice and converting the voice to an electric signal for making voice data; a voice recognition unit for recognizing the voice data and generating character information by converting the voice to a character string, or controlling an operation corresponding to the recognition result; and a control unit for controlling the voice recognition unit, wherein the control unit controls the voice recognition unit so as to make it generate character information when receiving a notice signal from an endoscope image imaging apparatus for giving effect to imaging an endoscope image if the voice recognition unit judges that the voice data is instruction information giving effect to making the character information be generated.

A voice recognition apparatus according to yet further aspect of the present invention comprises: a voice conversion unit for obtaining a voice and converting the voice to an electric signal for making voice data; a voice identification information output unit for recognizing the voice data and outputting voice identification information corresponding to the voice data, and a voice relation storage unit for at least storing the voice identification information, equipment control information relating to a control of the equipment corresponding to the voice identification information and voice-character information which is a characterization of the voice corresponding to the voice identification information; and a control unit for judging whether a state in which the voice recognition apparatus controls an operation of the equipment by the voice or a state in which the voice recognition unit converts the voice to a character string, and controlling the equipment or a conversion of the voice to a character string based on the equipment control information or voice-character information which are specified by the judgment result and the voice identification information.

### BRIEF DESCRIPTION OF THE DRAWINGS

FIG. 1 shows a conventional dictation-use microphone 110;

FIG. 2 is a conceptual diagram of a conventional voice recognition unit;

FIG. 3 shows an overall comprisal of an endoscopic surgery system according to a first embodiment;

FIG. 4 is a block diagram showing a connecting relationship of respective medical equipments constituting the endoscopic surgery system shown by FIG. 3;

FIG. 5 is a flow chart of a mode 1 of the present embodiment according to an embodiment 1 of the first embodiment;

FIG. 6 is a flow chart of a mode 2 of the present embodiment according to an embodiment 1 of the first embodiment;

FIG. 7A and 7B shows a part of an endoscopic endoscope 70 according to an embodiment 2 of the first embodiment;

FIG. 8A and 8B exemplifies display contents of a centralized display panel 21 according to the embodiment 2 of the first embodiment;

FIG. 9A, 9B and 9C shows states of equipping an endoscope display panel with lamps for informing either a dictation function or voice operation function being available according to the embodiment 2 of the first embodiment;

FIG. 10 is a flow chart according to the embodiment 2 of the first embodiment;

FIG. 11 is a flow chart according to the embodiment 1 of a second embodiment;

FIG. 12 is a flow chart according to the embodiment 2 of the second embodiment;

FIG. 13 is a conceptual diagram of a voice recognition unit according to a third embodiment; and

FIG. 14 illustrates a table storing control contents responding to a voice recognition mode according to the third embodiment.

### DESCRIPTION OF THE PREFERRED EMBODIMENTS

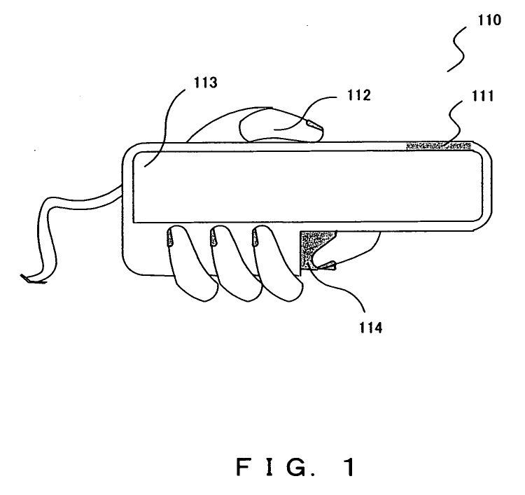

Referring to FIG. 1, there has been a case of an operator carrying out a surgery who is unable to press a start switch 114 because he holds an endoscope, an electric scalpel, et cetera. In such a case, the countermeasure has been for an assistant to press the start switch 114 or for the surgeon to press a foot switch in order to start a dictation. This accordingly requires collaboration between the surgeon and the assistant, thus making it difficult to input a voice timely.

And, if a voice is pronounced without pressing the dictation start switch 114 during an operation of a voice recognition engine (i.e., a voice operation control function), a problem has resulted in where an equipment is improperly prompted to function by the voice recognition engine misrecognizing the voice as a command. Or, if a dictation is carried out by avoiding a voice operation, a problem has resulted in where characters desired by an operator cannot be recorded.

In order to avoid the above noted problems, both a voice operation-use microphone and a dictation microphone have been prepared, which requires an alternative holding of the aforementioned microphones during a surgical procedure, hence a cumbersome operation.

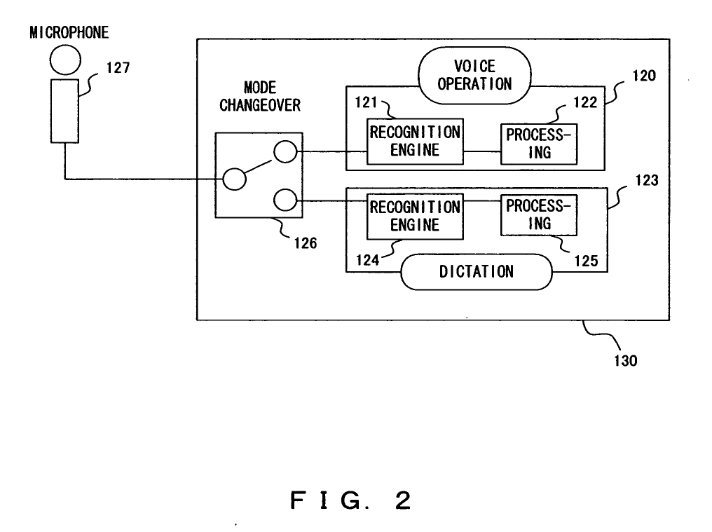

Meanwhile, in order to achieve both a voice operation control function and a dictation function in an endoscope system having the above described voice recognition function, there has been a necessity of comprising both a voice recognition engine 121 for a voice operation control function and a voice recognition engine 124 for a dictation which are shown by FIG. 2. This has ushered in a complexity of a program, a high cost and an increased examination process time.

According to an embodiment of the present invention, a medical practice support system comprises a voice conversion unit, a voice recognition unit and a control unit. The voice conversion unit is disposed for obtaining a voice and making voice data by converting the voice to an electric signal, corresponding to an A/D (analog to digital) converter for example. The voice recognition unit comprises a dictation function (i.e., a voice-to-character string conversion unit) and a voice operation function (i.e., a voice operation unit). The control unit corresponds to a CPU (central processing unit) for controlling the voice recognition unit.

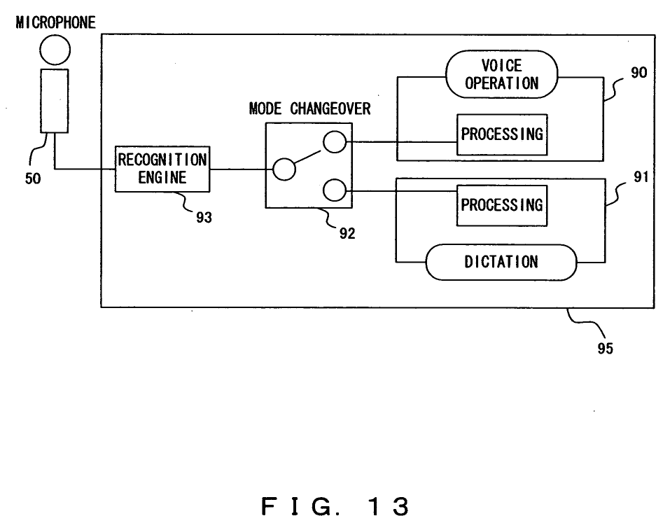

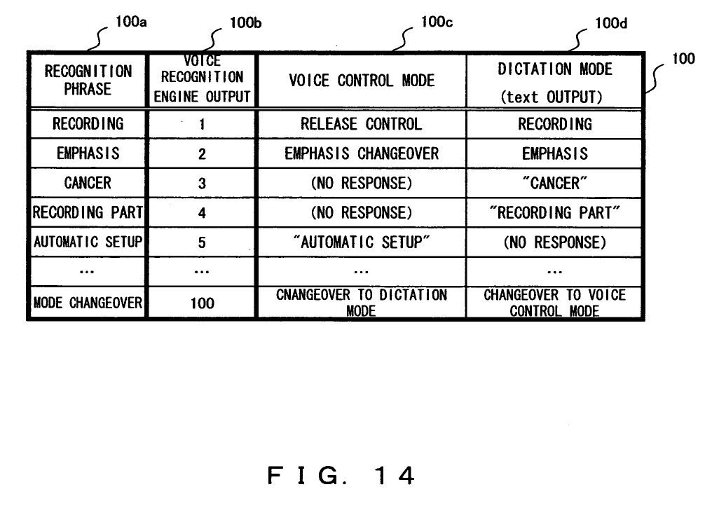

According to another embodiment of the present invention, the voice recognition unit comprises a voice identification information output unit and a voice relation storage unit. The voice identification information output unit corresponds to a voice recognition engine 93 shown by FIG. 13, and is disposed for recognizing the voice data and outputs voice identification information (i.e., a voice recognition engine output 100b) corresponding to the voice data. The voice relation storage unit, corresponding to a table 100 shown by FIG. 14, at least stores the voice identification information (i.e., a voice recognition engine output 100b), equipment control information (i.e., a voice control mode 100c) relating to a control of an equipment corresponding to the voice identification information, and voice-character information (i.e., a dictation mode 100d) which is a characterization of the voice corresponding to the voice identification information.

In this event, the control unit (i.e., a CPU) judges whether a state (i.e., a voice operation mode) in which the medical practice support system controls an operation of the equipment by the voice or a state (i.e., a dictation mode) in which the voice is converted to a character string, and controls the equipment or a conversion of the voice to a character string based on the equipment control information or voice-character information which are specified by the judgment result and the voice identification information (i.e., a voice recognition engine output 100b).

According to yet another embodiment of the present invention, if the dictation function (i.e., voice-to-character string conversion unit) has been driven for a predetermined time, or if a voice is not acquired for a predetermined time while the dictation function is driven, then the control unit makes a driving of the dictation function stop. In this event, a voice for the predetermined time is acquired by a control unit capable of controlling a recording for a predetermined time.

As described above, the present invention is capable of providing a further improved medical practice support system. Now the description is of preferred embodiments according to the present invention in the following.

### First Embodiment

In the first embodiment, the description is of a medical practice support system capable of easily changing over between a voice operation function and a dictation function.

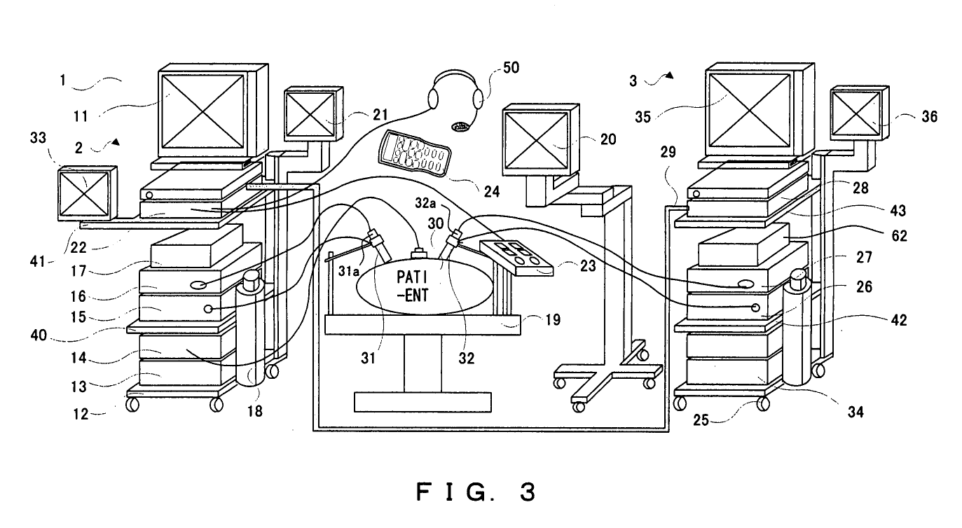

FIG. 3 shows an overall comprisal of an endoscopic surgery system according to the present embodiment. The endoscopic surgery system 1 places a first endoscopic surgery system 2 and a second endoscopic surgery system 3 on either side of a patient bed 19 that a patient 30 lies on.

The first endoscopic surgery system 2 and the second endoscopic surgery system 3 are respectively equipped with a first medical practice-use trolley 12 and a second medical practice-use trolley 25. A plurality of endoscope peripheral equipments are mounted to the first medical practice-use trolley 12 and a second medical practice-use trolley 25 for performing observation, examination, treatment, recording, et cetera. And movable stands are placed in the surrounding of the patient bed 19. An endoscope display panel 20 is mounted to the movable stand.

The first medical practice-use trolley 12 comprises a trolley top plate 41 on the upper-most top board, a trolley shelf 40 equipped at the middle tier and a bottom board part on the lower-most tier. An endoscope display panel 11 and a system controller 22 are placed on the trolley top plate 41. A VCR (video cassette recorder) 17, video processor 16 and endoscope light source apparatus 15 are placed on the trolley shelf 40. An air supply apparatus (i.e., aeroperitoneum apparatus) 14 and electric scalpel apparatus 13 are placed on the bottom board part. And a centralized operation panel 33 and a centralized display panel 21 are placed on the arm part of the first medical practice-use trolley 12. Furthermore, an ultrasonic observation apparatus, or a printer (both not shown herein) for example are mounted to the first medical practice-use trolley 12.

The centralized operation panel 33 is placed in an unsterilized zone and is disposed for a nurse, et al, to perform a centralized operation of the respective medical equipments. The centralized operation panel 33 allows a centralized management, control and operation of a medical equipment by using a pointing device such as a mouse and a touch panel (both not shown herein)

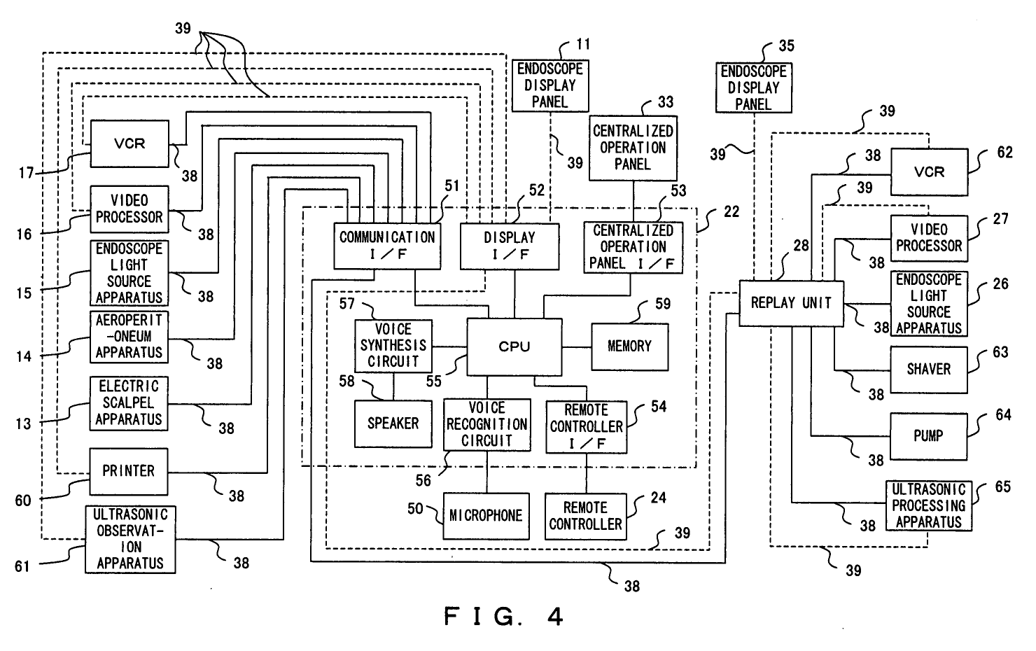

The respective medical equipments are connected to the system controller 22 by way of a serial interface cable (not shown herein), allowing a bidirectional communication. The system controller 22 also allows a connection of a microphone 50 (refer to FIG. 4).

The system controller 22 is capable of recognizing a voice input from the microphone 50 by a later described voice recognition circuit 56 and CPU 55 (refer to FIG. 4). Then, after recognizing the voice, the system controller 22 is capable of controlling each equipment based on a content of the recognized voice or making the recognition result displayed as a text.

The endoscope light source apparatus 15 is connected to a first endoscope 31 by way of a light guide cable for transmitting an illumination light. The illumination light of the endoscope light source apparatus 15, as it is supplied to the light guide cable for the first endoscope 31, illuminates an affected part inside the abdominal part, et cetera, of a patient 3 where the insertion part of the first endoscope 31 is inserted into.

An eye piece part of the first endoscope 31 is attached by a first camera head 31a comprising an imaging element. A use of the imaging element within the first camera head 31a images an optical image of an affected part, et cetera, by an observation optics system of the first endoscope 31. Then, the imaged optical image data is transmitted to the video processor 16 by way of a camera cable. The optical image data is then signal-processed by a signal processing circuit within the video processor 16 and a video picture signal is generated. Then, the video picture is output to the endoscope display panel 11 by way of the system controller 22 and an endoscope image of the affected part, et cetera, is displayed in the endoscope display panel 11.

The system controller 22 has a built-in external media recording apparatus (e.g., an MO (magneto optical) drive (not shown herein), et cetera. This enables the system controller 22 to read out an image recorded by the external recording media (e.g., an MO) and output to the endoscope display panel 11 for making it display. The system controller 22 is also connected to a network (i.e., an intra-hospital network) (not shown herein) by way of a cable (not shown herein). This enables the system controller 22 to acquire image data, et cetera, on the intra-hospital network and output to the first endoscope display panel 11 for making it display.

A gas container 18 filled with a carbon dioxide gas, et cetera, is connected to the aeroperitoneum apparatus 14. And a carbon dioxide gas can be supplied to an abdomen of the patient 3 by way of an aeroperitoneum tube 14a extending from the aeroperitoneum apparatus 14 to the patient 30.

The second medical practice-use trolley 25 comprises a trolley top plate 43 on the upper-most top board, a trolley shelf 42 equipped on the middle tier and a bottom board part on the lower-most tier. An endoscope display panel 35 and relay unit 28 are placed on the trolley top plate 43. A VCR 62, video processor 27 and endoscope light source apparatus 26 are placed on the trolley shelf 42. Other medical equipments, such as an ultrasonic treatment apparatus, lithotripsy apparatus, pump, shaver, et cetera, are mounted to the bottom plate part. Each equipment is connected to a relay unit 28 by way of a cable (not shown herein), thereby enabling a bidirectional communication.

The endoscope light source apparatus 26 is connected to a second endoscope 32 by way of a light cable for transmitting an illumination light. As the illumination light of the endoscope light source apparatus 26 is supplied to a light guide of the second endoscope 32, the illumination light illuminates an affected part, et cetera, of the abdomen of the patient 30 where the insertion part of the second endoscope 32 is inserted.

The eye piece part of the second endoscope 32 is equipped with a second camera head 32a comprising an imaging element. A use of the imaging element within the second camera head 32a images an optical image of the affected part, et cetera, by an observation optics system of the second endoscope 32. Then, the imaged optical image data is transmitted to the video processor 27 by way of a camera cable. The optical image data is signal-processed by the signal processing circuit within the video processor 27 and a video picture signal is generated. Then, the video picture signal is output to the endoscope display panel 35 by way of the system controller 22. As a result, an endoscope image of the affected part, et cetera, is displayed in the endoscope display pane 135. The system controller 22 and the relay unit 28 are connected by a relay cable 29.

Furthermore, the system controller 22 also allows a control by using an operator-use wireless remote controller (simply “remote controller” hereinafter) 24 for an operator to operate equipments from a sterilized zone. The first medical practice-use trolley 12 and the second medical practice-use trolley 25 can also be mounted by other equipments (e.g., a printer, an ultrasonic observation apparatus, et cetera).

FIG. 4 is a block diagram showing a connecting relationship of respective medical equipments constituting the endoscopic surgery system shown by FIG. 3. As shown by FIG. 4, the centralized operation panel 33, remote controller 24, VCR 17, video processor 16, endoscope light source apparatus 15, aeroperitoneum apparatus 14, electric scalpel apparatus 13, printer 60 (not shown in FIG. 3) and ultrasonic observation apparatus 61 (not shown in FIG. 3) are respectively connected to a communication interface 51 (an interface is simply denoted as “I/F” hereinafter) of the system controller 22 by way of communication cables 38. Data are exchanged between the system controller 22 and the respective equipments by way of the communication cables 38.

And the VCR 17, endoscope display panel 11, video processor 16, printer 60 and ultrasonic observation apparatus 61 are connected to a display I/F 52 of the system controller 22 by way of video picture cables 39. A video picture signal can be exchanged between the system controller 22 and the respective equipments by way of the video picture cables 39.

A VCR 62, video processor 27, endoscope light source apparatus 26, shaver 63 (not shown in FIG. 3), pump 64 (not shown in FIG. 3) and ultrasonic processing apparatus 65 (not shown in FIG. 3) are connected to the relay unit 28 by way of the communication cables 38. Data are exchanged between the relay unit 28 and the respective apparatuses by way of the communication cables 38.

And the endoscope display panel 35, video processor 27 and VCR 62 are connected to the relay unit 28 by the video picture cables 39. Video picture signals can be exchanged between the relay unit 28 and the respective equipments by way of the video picture cables 39.

And the relay unit 28 is connected to the system controller 22 by a cable 29 (refer to FIG. 3). The relay unit 28 is connected to a communication I/F 51 of the system controller 22 by way of the communication cable 38 within the cable 29. The relay unit 28 is also connected to the display I/F 52 of the system controller 22 by way of the video picture cable 39 within the cable 29.

The system controller 22 comprises a centralized operation panel I/F 53, a voice synthesis circuit 57, a CPU 55, a memory 59, a speaker 58, a voice recognition circuit 56 and a remote controller I/F 54, in addition to the communication I/F 51 and display I/F 52.

The voice recognition circuit 56 is a voice recognition unit for recognizing a voice signal from the microphone 50. The voice recognition circuit 56 comprises an A/D converter, an input voice memory, a voice operation-use memory, a dictation-use memory (or a voice operation/dictation-use memory), etcetera. The A/D converter performs an A/D conversion of a voice signal from the microphone 50. The input voice memory stores input voice data which is A/D converted by the A/D converter. The voice operation-use memory stores voice operation data for the CPU to compare whether or not voice data stored by the input voice memory is predefined command data. The dictation-use memory stores a voice wording table for the CPU 55 comparing whether or not voice data stored by the input voice memory is predefined dictation data.

The remote controller I/F 54 is disposed for exchanging data with the remote controller 24. The voice synthesis circuit 57 is disposed for synthesizing a voice and making the speaker 58 output the voice. The centralized operation panel I/F 53 is disposed for exchanging data with the centralized operation panel 33. Each of these circuits is controlled by the CPU 55.

And the system controller 22 is capable of making an external storage medium connect. Therefore, a control of the CPU 55 makes it possible to record image data in an external storage medium (not shown herein) and replay image data read out thereof.

And the system controller 22 comprises a network I/F (not shown herein). This enables a connection to a network such as WAN (wide area network), LAN (local area network), internet, intranet and extranet. Accordingly, the system controller 22 is capable of exchanging data with these external networks.

### Embodiment 1

Conventionally, a single microphone has been commonly used for a voice operation mode or a dictation mode, making a use of the microphone cumbersome. The present embodiment accordingly takes a countermeasure to such a problem which using a single microphone in a voice operation mode or a dictation mode.

A system controller 22 is capable of selecting modes 1 through 4 by a setting as follows:

Mode 1 is the one to make both the voice operation function and dictation function valid.

Mode 2 is the one to make the dictation function ordinarily valid, principally disabling a voice operation, except for recognizing a “dictation” and an “end of dictation” as command for a start and finish of a dictation by way of a voice operation.

Mode 3 is the one to make the dictation mode valid, allowing for instance a changeover between validating and invalidating the dictation function by turning on or off a dictation button equipped in a microphone.

Mode 4 is the one to make only the voice operation valid.

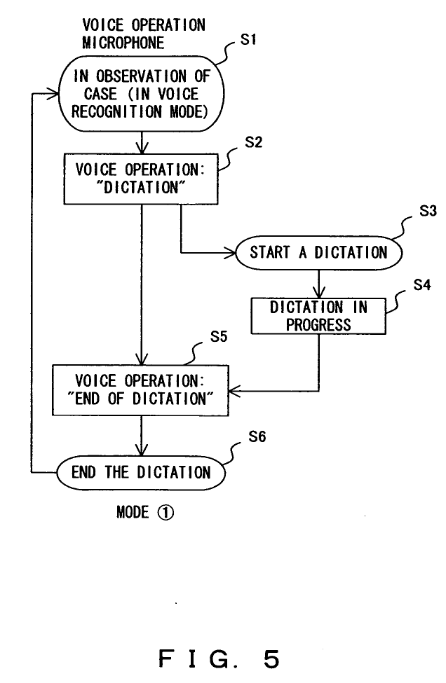

FIG. 5 shows a flow chart of the mode 1 according to the present embodiment. A surgical operator (sometimes simply “operator” hereinafter) for instance pronounces “dictation” to the microphone 50 while observing a symptom of an affected part through an endoscope during an operation by a voice operation (step 1; simply “S1” hereinafter). Then a voice recognition engine of the system controller 22 recognizes the voice (S2), and the CPU 55 changes a voice operation processing over to a dictation processing. This is described later.

As the voice is input by the microphone 50, the voice recognition engine which has been changed over to the dictation processing performs a dictation according to contents of the pronouncement of the operator (S3 and S4). Then, when the operator pronounces “end of dictation”, the voice recognition engine of the system controller 22 recognizes the pronouncement (S5). Based on the recognition result, the CPU 55 makes the dictation processing end (S6) to changeover to the voice operation processing, thus becoming a state allowing a voice recognition operation again (S1).

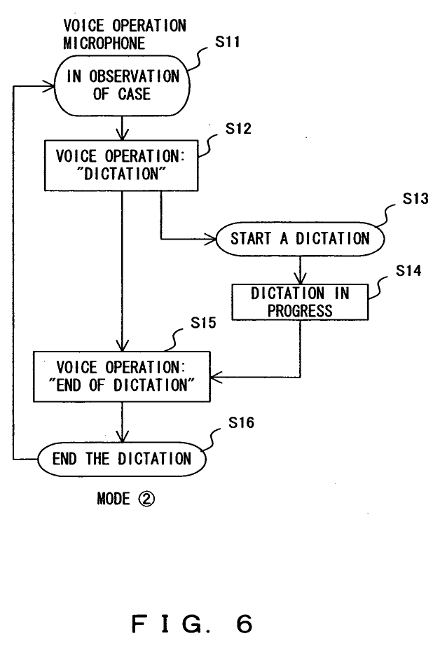

FIG. 6 shows a flow chart of the mode 2 according to the present embodiment. While observing a symptom of an affected part through an endoscope (S11), the operator for instance pronounces “dictation” to the microphone 50. Then the voice recognition engine of the system controller 22 recognizes the voice (S12) and the CPU 55 accordingly executes a dictation processing.

As the voice is input by the microphone 50, the voice recognition engine performs a dictation according to contents of the pronouncement of the operator (S13 and S14). Then, when the operator pronounces “end of dictation”, the voice recognition engine of the system controller 22 recognizes the pronouncement (S15). Based on the recognition result, the CPU 55 makes the dictation processing end (S16).

As described above, a changeover between the voice operation function and the dictation function, or a validation of the dictation function, is enabled by pronouncing “dictation” as trigger, thereby eliminating a cumbersome operation even in the case of using a single microphone.

### Embodiment 2

The description of the present embodiment is on the case of pressing a release & capture switch followed by automatically starting a dictation. Here, the release switch is the one disposed for being pressed in the case of storing an endoscope image as electronic data. The capture switch is the one disposed for being pressed in the case of printing out on a predetermined medium such as paper.

The case of performing a dictation most usually occurs after pressing either the release switch or the capture switch. Accordingly, the next description is of a technique for turning on the dictation function automatically for a predetermined time period after pressing the release switch or the capture switch and turning off the dictation function after passing a predefined time, in addition to the changeover operation between the voice operation mode and the dictation mode which has been described in the modes 1 and 2 of the embodiment 1. This can also be likewise applied to the case of the above described mode 3.

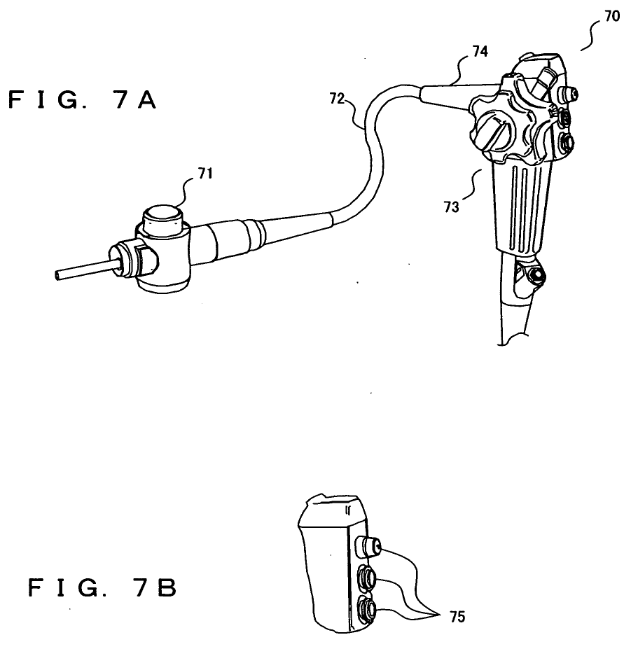

FIG. 7A and 7B shows a part of an endoscopic scope 70. Referring to FIG. 7A, the endoscopic scope 70 shows a light guide connecter 71, a scope cable 72, a scope operation part 73 and a scope holding part 74. FIG. 7B shows a partial enlargement of the scope operation part 73. Scope switches 75 are equipped on a side of the scope operation part 73. Either of the scope switches 75 is a release switch, or a capture switch. Alternatively the release switch and/or the capture switch may be comprised by a centralized operation panel 33.

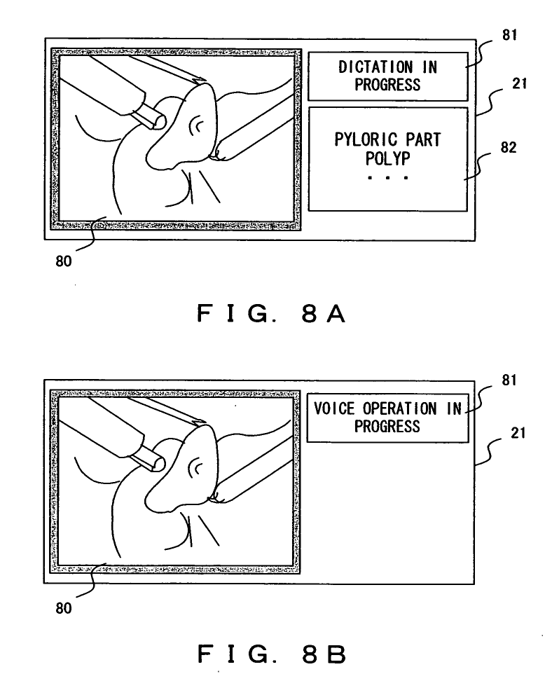

FIG. 8A and 8B exemplifies display contents of a centralized display panel 21. FIG. 8A exemplifies display contents at the time of a dictation mode. Display areas of the centralized display panel 21 comprise an endoscope image display area 80, a message area 81 and a dictation text display area 82.

The endoscope image display area 80 displays an endoscope image imaged by an endoscopic scope. The dictation text display area 82 displays dictation text data.

The message area 81 displays a message indicating a state of the dictation function being valid. In FIG. 8A, the message area 81 displays “dictation in progress”. Note that the display contents may be similar to the aforementioned, such as “recording in progress”, et cetera. A display of the “dictation in progress” may be flashed in a low speed so as not to give a physician unpleasantness

In such a case, the flashing speed may be one to two seconds for example.

If a display of the “dictation in progress” is made with the same screen as one for displaying a dictation text, identifying an image of which a physician wants to dictate on with dictation contents corresponding to the aforementioned image, thereby enabling a recording of a dictation text without an error. Except that there is a possible case of a physician wanting to concentrate on an endoscope image, and therefore a dictation text can be displayed simultaneously with an image which is desired to be dictated on in a separate display panel 20 and endoscope display panel 11. A dictation display destination can be easily set up by the system controller 22 for example.

FIG. 8B exemplifies display contents at the time of the voice operation mode, during which the message area 81 displays for example a flashing message “voice operation in progress” for indicating the voice operation function being valid. A steady display or a flashing display interval can easily be set by the system controller 22.

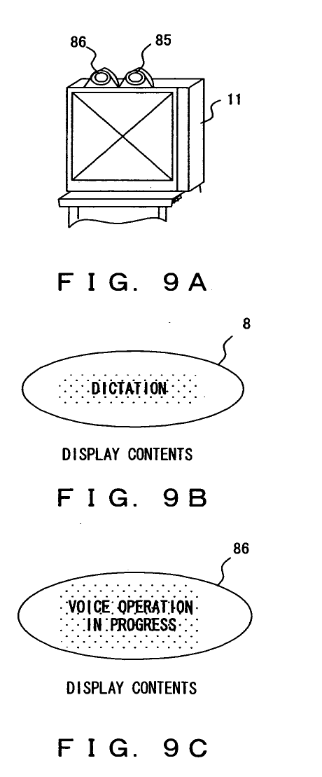

FIG. 9A, 9B and 9C shows an example of informing either a dictation function or a voice operation function being valid by lighting a lamp. Referring to FIG. 9A, lamps 85 and 86 are mounted to the upper part of the endoscope display panel 11.

The lamp 85 is disposed for being lit when the dictation function is turned on. FIG. 9B shows display contents of the lamp 85. When the dictation function is turned on, the lamp 85 is turned on by an instruction signal from the CPU 55. When the lamp 85 is lit, a “dictation” is displayed.

The lamp 86 is disposed for being lit when the voice operation function is turned on. FIG. 9C shows display contents of the lamp 86. When the voice operation function is turned on, the lamp 86 is turned on by an instruction signal from the CPU 55. When the lamp 86 is lit, a “voice operation in progress” is displayed.

There, a display light “dictation in progress” may be turned on for example in the endoscope display panel 11, separate display panel 20 or centralized display panel 21 in lieu of FIG. 8A (refer to FIG. 9A). In the case of performing a voice recognition following the end of a dictation, a display “voice operation in progress” may be turned on in lieu of FIG. 8B (refer to FIG. 9B).

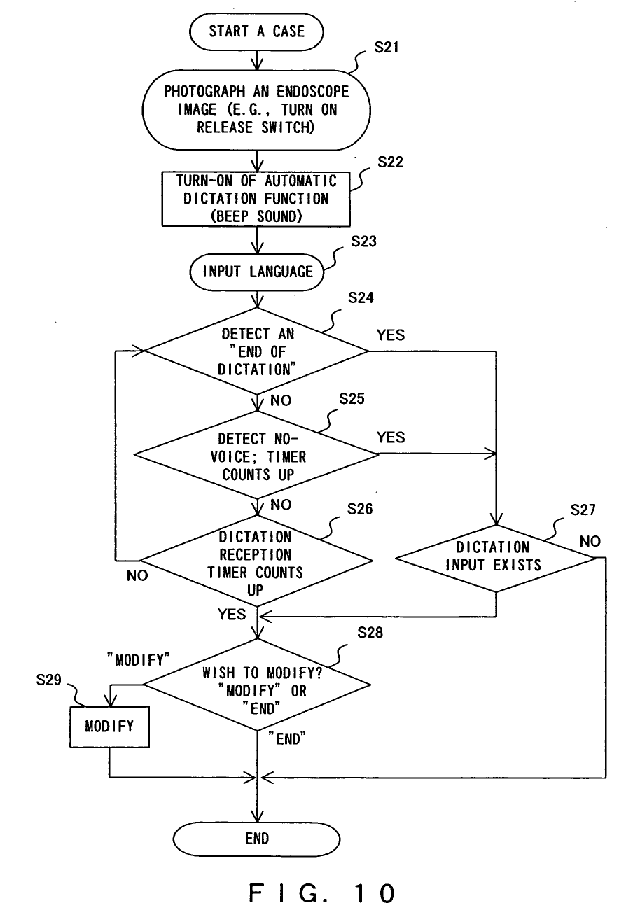

FIG. 10 is a flow chart according to the present embodiment. This flow is one being executed following the CPU 55 reading a program stored by a memory. First to turn on the release switch or the capture switch comprised by an endoscopic scope, et cetera, as shown by FIG. 7 when photographing an endoscope image after starting an endoscopic operation. Then, release processing (i.e., storing image data) or capture processing (i.e., printing out) is carried out (S21) Note that a “voice operation in progress” may be displayed along with an endoscope image, or a lamp (a flashing light) 85 may be placed nearby the endoscope image display area 80 (refer to FIG. 9) if a voice recognition is in operation (refer to FIG. 8B) in this event.

As the release switch, et cetera, if turned on, the CPU 55 turns on the dictation function by receiving the turn-on signal. Then, texts that are dictated thereafter are correlated with images photographed by the release switch.

As the dictation function is turned on, the speaker 58 is made to output a beep sound for example, thus transiting to the dictation mode (S22). A turn-on of the dictation mode enables the surgical operator to input a voice (S23). FIG. 8A shows the state of the centralized display panel 21 in this event. Alternative configuration may be to notify of a “dictation in progress” by using the lamp 85 (refer to FIG. 9B).

The S24 through S26 are loop processing for making the state of the dictation function being turned on continue for a predefined time, with the continued length of time being measured by the number of counts of a dictation reception timer. That is, as the dictation reception timer counts up to a predetermined number of counts, transits to processing for turning off the dictation function by ending the loop processing (i.e., proceed to “yes” in S26).

Furthermore, in the case of a no-voice state continuing for a predefined seconds or more during the loop processing indicated by S24 through S26 (i.e., the dictation function is turned on), transits to processing for turning off the dictation function by ending the loop processing (i.e., proceed to “yes” in S25). A continued time of the no-voice state is measured by the number of counts of a no-voice detection timer. That is, as the no-voice detection timer counts up to a predetermined number of counts, transits to processing for turning off the dictation function by ending the loop processing.

Meanwhile, if a voice “end of dictation” is input to the microphone 50 during the dictation function being turned on, transits to processing for turning off the dictation function independent of the dictation reception timer (i.e., proceed to “yes” in S24).

If proceeding to “yes” in S24 or “yes” in S25, judges whether or not a text is input by a dictation (S27). For example, it is possible to validate whether a dictation is carried out during the dictation function being turned on by detecting whether a text is input in the dictation text display area 82 shown by FIG. 8A.

If a dictation text is input (proceed to “yes” in S27), or if the dictation reception timer counts up to a predefined number of counts (proceed to “yes” in S26), makes the screen of the display panel 21 display “wish to end?” wish to modify?” for example (S28). If an “end” is input by a voice, ends the dictation (proceed to “end” in S28).

If a “modify” is input (proceed to “modify” in S28), then modify the dictation text input to the dictation text display area 82 (S29). The modification work is carried out by an assistant by using a key board, touch panel, etcetera (neither shown herein). Alternatively, display error input candidate words for inputting a modification of candidate words by dictation software.

Note that an input modification work is of course enabled during a dictation in progress. Also, there is a conceivable case of some physician wishing to put a surgical procedure in a higher priority even if there has been an erroneous input. Accordingly, whether or not to transit to the modification mode can be discretionarily selected by the system controller.

If a dictation text is not input in S27 (proceed to “no” in S27), ends the current flow.

If going back to the voice operation mode after ending the dictation, a “voice operation in progress” may be displayed in the endoscopic image (refer to FIG. 8B), or the light 86 may be turned on (refer to FIG. 9C). Incidentally in the flow shown by FIG. 10, a dictation text is stored in the memory 59, being correlated with an endoscope image corresponding to the text at the timing of the dictation function being turned off.

Note that the processing of a dictation or a voice recognition may be carried out by a CPU reading out a program (i.e., software) having these functions, in lieu of being limited to the hardware within the system controller 22 carrying out. Meanwhile, the system controller 22 sets a timer setup of the dictation turn-on timer, a setup for a no-voice detection time and a voice input detection level.

The present embodiment has described the case of changing over the modes by a camera switch and a remote controller switch as one example, a transition to the dictation mode, however, may be carried out following a detection of a “release (photographing)” or a “capture” by a voice operation.

If freeze processing is conducted, a dictation may be carried out only during a freeze after the end of the processing in S21. This enables a dictation of diagnostic contents during the freeze. Note that the centralized operation panel 33 allows a setting of each timer described in the flow chart shown by FIG. 10.

According to the above described configuration, the enabled is an automatic transition to the dictation mode after pressing the release switch or the capture switch, thereby enabling the surgical operator to transfer to the dictation operation smoothly.

### Second Embodiment

### Embodiment 1

The embodiment 2 (refer to FIG. 10) of the first embodiment is configured to transit to the dictation mode at every time of a release or a capture, a transition to the dictation mode, however, is cumbersome depending on a surgical procedure.

The medical practice support system according to the present embodiment accordingly implements the following. For example, the present embodiment is configured to transit to the dictation mode only in the case of performing a release or a capture within a predetermined seconds of pronouncing “dictation” for example. And if a “dictation” is not pronounced, an endoscope observation image is switched on after a release or a capture is carried out. Such a configuration enables a transition to the dictation mode only on as required basis.

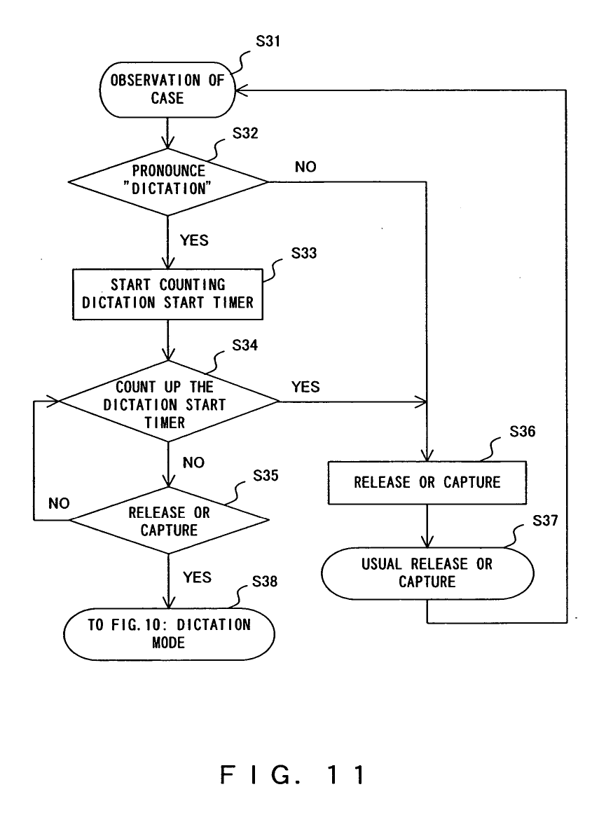

FIG. 11 shows a flow chart according to the present embodiment. This flow is the one for the CPU 55 reading a program according to the present embodiment stored by a memory and executing it. First, in the case of observing a target part by the endoscopic scope (S31), an operator pronounces “dictation” to the microphone 50 (proceed to “yes” in S32). Then, counting of the dictation start timer is started (S33). The dictation start timer is disposed for measuring a time for the dictation function being turned on, and is preset with a predefined time.

The dictation start timer counts up until the release switch or the capture switch is pressed within a predefined time (S34). In this event, if the release switch or the capture switch is pressed (S35), transits to the dictation mode (i.e., the processing in S22 and thereafter as shown by FIG. 10).

If neither the release switch nor the capture switch is pressed within a predefined time (proceed to “yes” in S34), a transition to the dictation mode is not required. If the release switch or the capture switch is pressed after passing the predefined time (S36), a normal release or a capture is accordingly carried out (S37).

Likewise, if the operator does not pronounce “dictation” to the microphone 50 in S32 (proceed to “no” in S32), and yet if the release switch or the capture switch is pressed (S36), a normal release or a capture is carried out (S37).

Note that a discretionary switch (e.g., a foot switch, a different camera switch or a key board) may be pressed in lieu of pronouncing “dictation”.

The above described processing enables a transition to the dictation mode on as required basis.

### Embodiment 2

This embodiment is a modified example of the embodiment 2 (described in association of FIG. 10) of the first embodiment. The present embodiment is configured in such a way that, if the processing of a release or a capture is performed again during the dictation being turned on, an image as the subject of a dictation automatically changes over to new image and the processing is carried out for the new image according to the flow chart shown by FIG. 10.

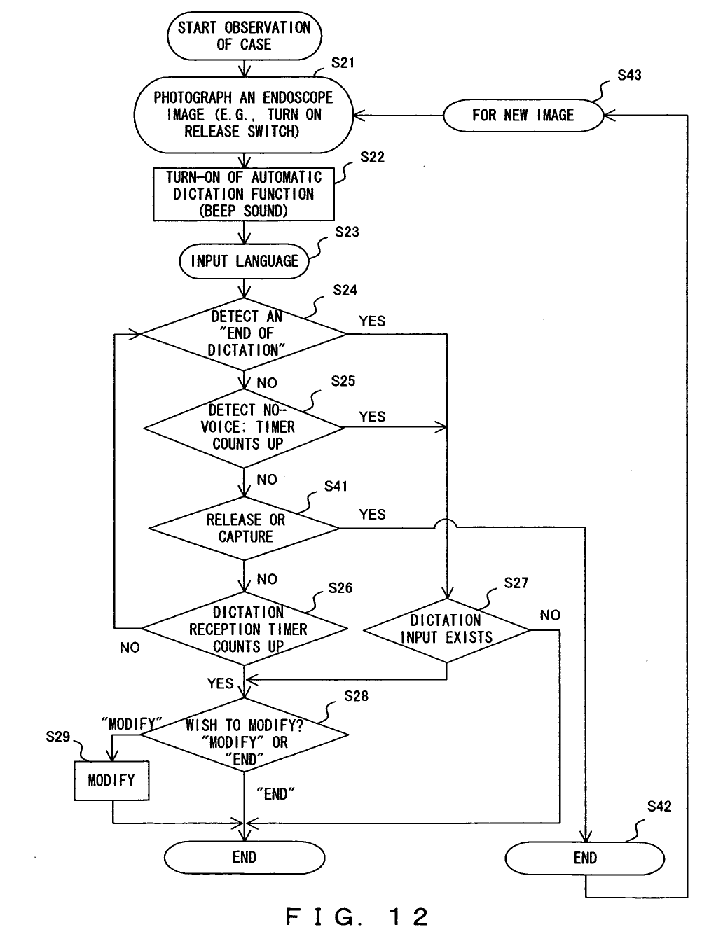

FIG. 12 shows a flow chart according to the present embodiment. FIG. 12 has added S41 between S25 and S26 of the flow chart shown by FIG. 10. When the release switch or the capture switch is pressed in S41, a dictation is finished for the current endoscope image (S42), followed by carrying out the processing of S21 and thereafter as described in association of FIG. 10 for the next endoscope image (i.e., new image).

The above described processing enables an endoscope image and a dictation text corresponding thereto to be stored in the memory 59 by correlating them at any given time.

### Third Embodiment

The next description is of a medical practice support system for making the redundant functions of a voice operation-use voice recognition engine and a dictation-use voice recognition engine common according to this embodiment. That is, the description of the present embodiment is on commonizing a voice recognition engine for a voice operation and for a dictation in the mode 1 (refer to FIG. 5) and mode 2 (refer to FIG. 6). As described above, the voice operation-use recognition engine 121 and the dictation-use recognition engine 124 independently coexist in the conventional example (refer to FIG. 2), whereas the present embodiment describes the fact of making a recognition engine common.

FIG. 13 is a conceptual diagram of a voice recognition unit according to the present embodiment, in which the voice recognition unit 95 corresponds to the above described voice recognition circuit 56. A single voice recognition engine 93 is mounted to the voice recognition unit 95. And the voice recognition engine 93 comprises a table 100 storing control contents according to a voice recognition mode as shown by FIG. 14. And the modes can be changed over by a mode changeover unit 92 (e.g., a CPU). That is, a mode changeover operation of the mode changeover unit 92 makes it possible to perform voice operation processing 90 and dictation processing 91.

FIG. 14 illustrates the table 100 storing control contents responding to a voice recognition mode according to the present embodiment. The table 100 comprises data items, i.e., a “recognition phrase” 100a, a “voice recognition engine output 100b, a “voice control mode” 100c, a “dictation mode” 100d.

For instance, a “recording” is pronounced to the microphone 50, a voice signal input therefrom is transmitted to the voice recognition engine 93, which then performs a voice recognition to output a recognition result number “1” (i.e., a voice recognition engine output 100b=“1”) as shown by the table 100 in FIG. 14.

Having received the recognition result “1”, the CPU 55 carries out the following operation according to the table 100. For example, if the current recognition mode is the “voice operation control mode”, the CPU 55 judges as a “release control” based on the voice recognition engine output 100b=“1”. The CPU 55 accordingly outputs a release signal to equipments as the subjects of releasing, which are connected to the system controller 22. The observation image is accordingly recorded by the respective connecting equipments.

Meanwhile, if the current recognition mode is the “dictation mode”, the CPU 55 executes a “recording” of a dictation text based on the voice recognition engine output 100b=“1”.

And, if a “recording part” is pronounced to the microphone 50, the voice recognition engine 93 outputs a recognition result number “4” (i.e., a voice recognition engine output 100b=“4”) through the same processing as described above.

Having received the recognition result “4”, the CPU 55 executes the following operation according to the table 100. For instance, if the current recognition mode is the “voice operation control mode”, the CPU 55 controls nothing according to the voice recognition engine output 100b=“4”.

In the meantime, if the current recognition mode is the “dictation mode” for instance, the CPU 55 judges as a “recording part (text output)”. Then, carries out a text display of “recording part” in a predefined display area (i.e., the comment column) of the endoscope display panel 11 and centralized display panel 21. If the release button is pressed in this event, an intended comment is recorded together with the endoscope image in the respective recording apparatus while the aforementioned comment is displayed.

In either mode, if a “mode changeover” is pronounced to the microphone 50, the mode changeover unit 92 changes over from the current mode to the other mode based on a voice recognition engine output 100b=“100”. Note that the voice recognition engine 93 is also capable of identifying a command such as an automatic setup transmitted from a sterilized area by way of the system controller 22. Note that the present embodiment may be combined with the first and second embodiments.

The above described configuration enables the voice recognition engine to be commonized as one, thus eliminating a redundancy of the voice recognition engine and generating it simply and at a low lost.

The first, second and third embodiments enable an easy changeover between the voice operation function and the dictation function. Also enabled is to make the redundant functions of the voice operation-use voice recognition engine and the dictation-use voice recognition engine common, thereby making it possible to reduce a software development cost.

As described thus far, a use of the present invention enables an accomplishment of a further improved medical practice support system. Note that the present invention can be embodied by appropriately changing within the purpose and scope thereof, in lieu of being limited by the above described embodiments.

What is claimed is:

1. A medical practice support system, comprising:
a voice conversion unit for obtaining a voice and converting the voice to an electric signal for making voice data;
a voice recognition unit for recognizing the voice data and generating character information by converting the voice to a character string, or controlling an operation corresponding to the recognition result; and
a control unit for controlling the voice recognition unit, wherein
the control unit controls the voice recognition unit to make it generate character information if the voice recognition unit judges that the voice data is instruction information for making the character string be generated.

2. The medical practice support system according to claim 1, wherein
said voice recognition unit comprises
a voice-to-character string conversion unit for recognizing said voice data obtained by said voice conversion unit and converting the voice to a character string, and
a voice operation unit for recognizing said voice data obtained by said voice conversion unit and controlling an operation of said equipment corresponding to the recognition result, wherein
said control unit controls a drive of the voice-to-character string conversion unit and voice operation unit.

3. The medical practice support system according to claim 2, wherein
said control unit stops an operation instruction to said equipment controlled by said voice operation unit while said voice-to-character string conversion unit is driven.

4. The medical practice support system according to claim 2, wherein
said control unit stops a drive of said voice-to-character string conversion unit if the voice-to-character string conversion unit judges that said voice data is instruction information so as to make a drive of the voice-to-character string conversion unit stop.

5. The medical practice support system according to claim 4, wherein
said control unit makes said voice operation unit drive if the voice-to-character string conversion unit judges that said voice data is instruction information so as to make a drive of the voice-to-character string conversion unit stop.

6. The medical practice support system according to claim 1, wherein
said voice recognition unit comprises
a voice identification information output unit for recognizing said voice data and outputting voice identification information corresponding to the voice data, and
a voice relation storage unit for at least storing the voice identification information, equipment control information relating to a control of said equipment corresponding to the voice identification information, and voice-character information which is a characterization of the voice corresponding to the voice identification information, wherein
said control unit judges whether a state in which the voice recognition unit controls an operation of the equipment by said voice or a state in which the voice recognition unit converts the voice to a character string, and controls the equipment or a conversion of the voice to a character string based on the equipment control information or voice-character information which are specified by the judgment result or the voice identification information.

7. A medical practice support system, comprising:
a voice conversion unit for obtaining a voice and converting the voice to an electric signal for making voice data;
a voice recognition unit for recognizing the voice data and generating character information by converting the voice to a character string, or controlling an operation corresponding to the recognition result; and
a control unit for controlling the voice recognition unit, wherein
the control unit controls the voice recognition unit so as to make it generate character information if the control unit receive a notice signal for giving effect to imaging an endoscope image.

8. The medical practice support system according to claim 7, wherein
said voice recognition unit comprises
a voice-to-character string conversion unit for recognizing said voice data obtained by said voice conversion unit and converting the voice to a character string, and
a voice operation unit for recognizing said voice data obtained by said voice conversion unit and controlling an operation of said equipment corresponding to the recognition result, wherein
said control unit controls a drive of the voice-to-character string conversion unit and voice operation unit.

9. The medical practice support system according to claim 8, wherein
said control unit makes a drive of said voice-to-character string conversion unit stop if it has been driven for a predetermined time.

10. The medical practice support system according to claim 8, wherein
said control unit makes a drive of said voice-to-character string conversion unit stop if a voice has not been obtained for a predetermined time while the voice-to-character string conversion unit is driven.

11. The medical practice support system according to claim 8, further comprising
a voice-character edit unit for editing a voice character which is converted to a character string by said voice-to-character string conversion unit after a driving thereof stops.

12. The medical practice support system according to claim 8, further comprising
a storage unit for storing a voice-character, which is converted to a character string while said voice-to-character string conversion unit is driven, and said endoscope image, which corresponds to said endoscope image acquisition signal of the last time, by correlating them if a driving of the voice-to-character string conversion unit is stopped by the said control unit receiving said notice signal again while the voice-to-character string conversion unit is driven.

13. The medical practice support system according to claim 7, wherein
said voice recognition unit comprises:
a voice identification information output unit for recognizing said voice data and outputting voice identification information corresponding to the voice data, and
a voice relation storage unit for at least storing the voice identification information, equipment control information relating to a control of said equipment corresponding to the voice identification information and voice-character information which is a characterization of the voice corresponding to the voice identification information, wherein
said control unit judges whether a state in which the voice recognition unit controls an operation of the equipment by said voice or a state in which the voice recognition unit converts the voice to a character string, and controls the equipment or a conversion of the voice to a character string based on the equipment control information or voice-character information which are specified by the judgment result and the voice identification information.

14. A medical practice support system, comprising:
a voice conversion unit for obtaining a voice and converting the voice to an electric signal for making voice data;
a voice recognition unit for recognizing the voice data and generating character information by converting the voice to a character string, or controlling an operation corresponding to the recognition result; and
a control unit for controlling the voice recognition unit, wherein
the control unit controls the voice recognition unit so as to make it generate character information when receiving a notice signal from an endoscope image imaging apparatus for giving effect to imaging an endoscope image if the voice recognition unit judges that the voice data is instruction information giving effect to making the character information be generated.

15. The medical practice support system according to claim 14, wherein
said voice recognition unit comprises:
a voice identification information output unit for recognizing said voice data and outputting voice identification information corresponding to the voice data, and
a voice relation storage unit for at least storing the voice identification information, equipment control information relating to a control of said equipment corresponding to the voice identification information and voice-character information which is a characterization of the voice corresponding to the voice identification information, wherein
said control unit judges whether a state in which the voice recognition unit controls an operation of the equipment by said voice or a state in which the voice recognition unit converts the voice to a character string, and controls the equipment or a conversion of the voice to a character string based on the equipment control information or voice-character information which are specified by the judgment result and the voice identification information.

16. A voice recognition apparatus, comprising:
a voice conversion unit for obtaining a voice and converting the voice to an electric signal for making voice data;
a voice identification information output unit for recognizing the voice data and outputting voice identification information corresponding to the voice data; and
a voice relation storage unit for at least storing the voice identification information, equipment control information relating to a control of the equipment corresponding to the voice identification information and voice-character information which is a characterization of the voice corresponding to the voice identification information; and
a control unit for judging whether a state in which the voice recognition apparatus controls an operation of the equipment by the voice or a state in which the voice recognition unit converts the voice to a character string, and controlling the equipment or a conversion of the voice to a character string based on the equipment control information or voice-character information which are specified by the judgment result or the voice identification information.

17. A control method for a medical practice support system comprising a voice conversion unit for obtaining a voice and converting the voice to an electric signal for making voice data; a voice recognition unit for recognizing the voice data and generating character information by converting the voice to a character string, or controlling an operation corresponding to the recognition result; and a control unit for controlling the voice recognition unit, comprising the step of
making character information be generated by the control unit controlling the voice recognition unit if the voice recognition unit judges that the voice data is instruction information giving effect to making the character information be generated.

18. A control method for a medical practice support system comprising a voice conversion unit for obtaining a voice and converting the voice to an electric signal for making voice data; a voice recognition unit for recognizing the voice data and generating character information by converting the voice to a character string, or controlling an operation of an equipment corresponding to the recognition result; and a control unit for controlling the voice recognition unit, comprising the steps of
receiving, by the control unit, an endoscope image acquisition signal transmitted from an endoscope image imaging apparatus giving effect to imaging an endoscope image, and making character information be generated by the voice recognition unit which is controlled by the control unit.

19. A control method for a medical practice support system comprising a voice conversion unit for obtaining a voice and converting the voice to an electric signal for making voice data; a voice recognition unit for recognizing the voice data and generating character information by converting the voice to a character string, or controlling an operation of an equipment corresponding to the recognition result; and a control unit for controlling the voice recognition unit, comprising the step of
making character information be generated by controlling the voice recognition unit if the control unit receives a notice signal from an endoscope image imaging apparatus for giving effect to imaging an endoscope image when the voice recognition unit judges that the voice data is instruction information giving effect to making the character information be generated.

20. A control method for a voice recognition apparatus comprising a voice conversion unit for obtaining a voice and converting the voice to an electric signal for making voice data; a voice identification information output unit for recognizing said voice data and outputting voice identification information corresponding to the voice data; and a voice relation storage unit for at least storing the voice identification information, equipment control information relating to a control of said equipment corresponding to the voice identification information and voice-character information which is a characterization of the voice corresponding to the voice identification information, comprising the steps of
judging whether a state in which the voice recognition apparatus controls an operation of the equipment by said voice or a state in which the voice recognition unit converts the voice to a character string, and controlling the equipment or converting the voice to a character string based on the equipment control information or voice-character information which are specified by the judgment result or the voice identification information.
